(19) United States
(12) Patent Application Publication
(10) Pub. No.: US 2024/0104751 A1
(43) Pub. Date: Mar. 28, 2024

(54) DETECTION SYSTEM, DETECTION METHOD, PROGRAM, AND DETECTION MODULE

(71) Applicant: NIPPON CHEMI-CON CORPORATION, Tokyo (JP)

(72) Inventors: Ryo Sato, Tokyo (JP); Katsuya Tamaki, Tokyo (JP); Naohisa Shibata, Tokyo (JP)

(73) Assignee: NIPPON CHEMI-CON CORPORATION, Tokyo (JP)

(21) Appl. No.: 18/369,389

(22) Filed: Sep. 18, 2023

(30) Foreign Application Priority Data
Sep. 28, 2022 (JP) 2022-155109

(51) Int. Cl. G06T 7/254; G06T 7/00; G06T 7/521; G06T 7/55

(52) U.S. Cl. CPC G06T 7/254; G06T 7/0002; G06T 7/521; G06T 7/55; G06T 2207/30196

(57) ABSTRACT

A detection system includes an imaging unit configured to acquire in advance a first distance image indicating a background and acquire a second distance image including at least the background and a target object, and a processing unit configured to calculate a first virtual volume indicating the background from the first distance image, calculate a second virtual volume indicating the target object from the second distance image, and compare the first virtual volume with the second virtual volume to detect the target object.

### CROSS-REFERENCE TO RELATED APPLICATIONS

This application is entitled to the benefit of priority of Japanese Patent Application No. 2022-155109, filed on Sep. 28, 2022, the contents of which are hereby incorporated by reference.

### BACKGROUND OF THE INVENTION

### i) Field of the Invention

The present disclosure relates to a detection technique used, for example, for human state detection as a target object to be detected.

### ii) DESCRIPTION OF THE RELATED ART

A Time-of-Flight Camera (ToF camera) is a camera capable of irradiating a target object with light and measuring three-dimensional information (distance image) from the target object using an arrival time of reflected light.

Regarding the detection technique by ToF, it is known that a difference image is acquired from a captured image by background difference processing, a head is estimated from a human object included in the difference image, a distance between the head and a floor surface of a target space is calculated to determine a human posture, and a human behavior is detected from the posture and position information of an object (for example, JP 2015-130014 A).

Regarding abnormality detection of a target object, it is known to measure a time indicating a stationary state of the target object and to determine that there is an abnormality when the time exceeds a threshold (for example, JP 2008-052631 A).

Regarding abnormality monitoring, it is known that a temporal change of a distance of a measurement point in an arbitrary region in a distance image is monitored, and when the temporal change exceeds a certain range, an abnormality is recognized (for example, JP 2019-124659 A).

Regarding detection of a moving object, it is known that a movement vector and a volume of an object in a detection space are calculated from a distance image, and a detection target is detected on the basis of the movement vector and the volume (for example, JP 2022-051172 A).

### BRIEF SUMMARY OF THE INVENTION

In a case where a target object whose state such as behavior is to be detected is, for example, a human, there is a problem to be prioritized over acquisition of state information such as abnormality detection, such as attribute information such as a portrait and information regarding privacy. In imaging by a general camera, even when abnormality can be detected, personal information such as privacy cannot be protected.

Meanwhile, according to the distance image obtained by the ToF camera, even when the target object is a human, there is an advantage that it is possible to prevent privacy and exposure of personal information.

The inventors of the present disclosure have obtained knowledge that a virtual volume is acquired by a pixel of a distance image indicating a distance between a target object and a sensor, and a state of the target object can be detected from a change in the volume.

Therefore, an object of the present disclosure is to acquire a virtual volume acquired from a distance image obtained by imaging, and detect a state such as detection or abnormality of a target object using the virtual volume.

According to an aspect of a detection system of the present disclosure, there is provided a detection system including: an imaging unit configured to acquire in advance a first distance image indicating a background and acquire a second distance image including at least the background and a target object; and a processing unit configured to calculate a first virtual volume indicating the background from the first distance image, calculates a second virtual volume indicating the target object from the second distance image, and compare the first virtual volume with the second virtual volume to detect the target object.

According to an aspect of a detection system of the present disclosure, there is provided a detection system including: an imaging unit configured to acquire in advance a first distance image indicating a background together with an object other than a target object to be detected, and acquire a second distance image including the background, the object, and the target object; and a processing unit configured to calculate a first virtual volume indicating the object and the background from the first distance image, calculate a second virtual volume indicating the target object and the object from the second distance image, and compare the first virtual volume with the second virtual volume to detect the target object.

According to an aspect of a detection method of the present disclosure, there is provided a detection method including: acquiring, by an imaging unit, a first distance image indicating a background for a target object to be detected in advance, and acquiring a second distance image including at least the background and the target object; and calculating, by a processing unit, a first virtual volume indicating the background from the first distance image, calculating a second virtual volume indicating the target object from the second distance image, and comparing the first virtual volume with the second virtual volume to detect the target object.

According to an aspect of a program of the present disclosure, there is provided a program for causing a computer to execute: acquiring in advance a first distance image indicating a background for a target object to be detected; acquiring a second distance image including at least the background and the target object; calculating a first virtual volume indicating the background from the first distance image; calculating a second virtual volume indicating the target object from the second distance image; and comparing the first virtual volume with the second virtual volume to detect the target object and calculating a maximum height from the target object or a virtual area of the target object.

According to an aspect of a detection module of the present disclosure, there is provided a detection module including: an imaging unit configured to acquire in advance a first distance image indicating a background for a target object to be detected and acquire a second distance image including at least the background and the target object; and a processing unit configured to calculate a first virtual volume indicating the background from the first distance image, calculate a second virtual volume indicating the target object from the second distance image, and compare the first virtual volume with the second virtual volume to detect the target object.

### BRIEF DESCRIPTION OF THE SEVERAL VIEWS OF THE DRAWING

FIG. 1 is a diagram illustrating a detection system according to a first embodiment.

FIG. 2A is a diagram illustrating a real image indicating a state X, and FIG. 2B is a diagram illustrating an example of a composite image indicating the state X.

FIG. 3A is a diagram illustrating a real image indicating a state Y, and FIG. 3B is a diagram illustrating an example of a composite image indicating the state Y.

FIG. 4 is a flowchart illustrating a processing procedure of a detection system according to the first embodiment.

FIG. 5 is a diagram illustrating a detection system according to a second embodiment.

FIG. 6 is a diagram illustrating an example of a detection information database.

FIG. 7 is a flowchart illustrating a processing procedure of the detection system according to the second embodiment.

FIGS. 8A, 8B and 8C are respectively a diagram illustrating a real image example according to a state A, a state B, and a state C.

FIG. 9 is a diagram illustrating a state detection table related to the state A, the state B, and the state C.

FIG. 10A is a diagram illustrating an example of a background distance image GdA according to a third embodiment, FIG. 10B is a diagram illustrating an example of a background/object distance image GdB according to the third embodiment, and FIG. 10C is a diagram illustrating an example of a background/object/target object distance image GdC according to the third embodiment.

FIG. 11 is a diagram illustrating an example of a detection information database according to the third embodiment.

FIG. 12 is a flowchart illustrating a processing procedure of the detection system according to the third embodiment.

FIG. 13A is a flowchart illustrating a procedure of acquiring a background difference information, FIG. 13B is a flowchart illustrating a procedure of acquiring virtual volume difference information, and FIG. 13C is a flowchart illustrating a processing procedure of detecting the presence of the target object.

FIG. 14A is a flowchart illustrating a processing procedure of state detection of the target object, and FIG. 14B is a flowchart illustrating a processing procedure of abnormality detection of the target object.

FIG. 15 is a diagram illustrating a detection module according to an example.

### DETAILED DESCRIPTION OF THE INVENTION

### First Embodiment

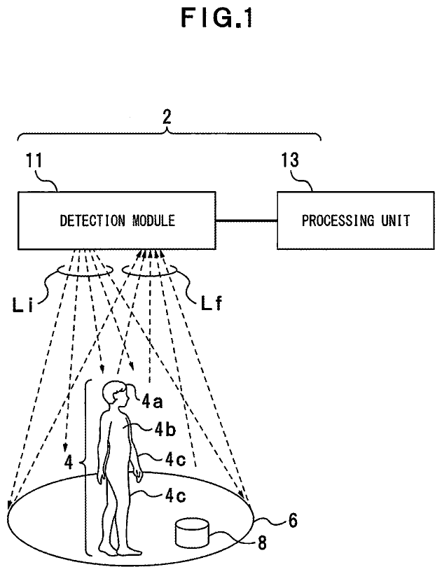

FIG. 1 illustrates a detection system 2 and a detection target according to a first embodiment. The configuration illustrated in FIG. 1 is an example, and the present disclosure is not limited to such a configuration.

The detection system 2 acquires a background distance image Gd1 (hereinafter, it is simply referred to as a “background image Gd1”) and a composite distance image Gd2 (hereinafter, it is simply referred to as a “composite image Gd2”), and detects the state of the target object 4 using the background image Gd1 and the composite image Gd2. That is, the detection system 2 detects a state change of the target object 4, which is a detection target, from a plurality of frames indicating the image. The detection of the target object 4 includes recognition of the state change of the target object 4 or ascertainment of the state change of the target object 4, and any of these may be used for the state detection. In the detection system 2, the background image Gd1 is an example of a first distance image of the present disclosure, and the composite image Gd2 is an example of a second distance image of the present disclosure. In the present disclosure, for the acquisition of the first distance image, the first distance image indicating the background 6 may be acquired in advance, the first distance image may be re-acquired after a certain period of time from the acquisition, and the previous first distance image may be updated to the re-acquired first distance image.

The background image Gd1 is an image indicating a distance from the target object 4 to the background 6. The target object 4 is an object whose state changes, such as a human or a robot. When the target object 4 whose state is to be detected is, for example, a human, the behavior of the target object 4 such as a head 4a, a body 4b, or a limb 4c including hands and legs is illustrated in the composite image Gd2. The background 6 is a place or a water surface in a bathroom, a living room, or the like where the target object 4 is present. In other words, the background 6 is a stay area of the target object 4 and a state detection area thereof.

The composite image Gd2 includes the background 6 and an object 8 other than the target object 4, and is an image indicating a distance therebetween. The object 8 is assumed to be a moving body or a stationary object other than the target object 4 present in a state detection area.

### <Detection System 2>

As illustrated in FIG. 1, the detection system 2 includes a detection module 11 and a processing unit 13.

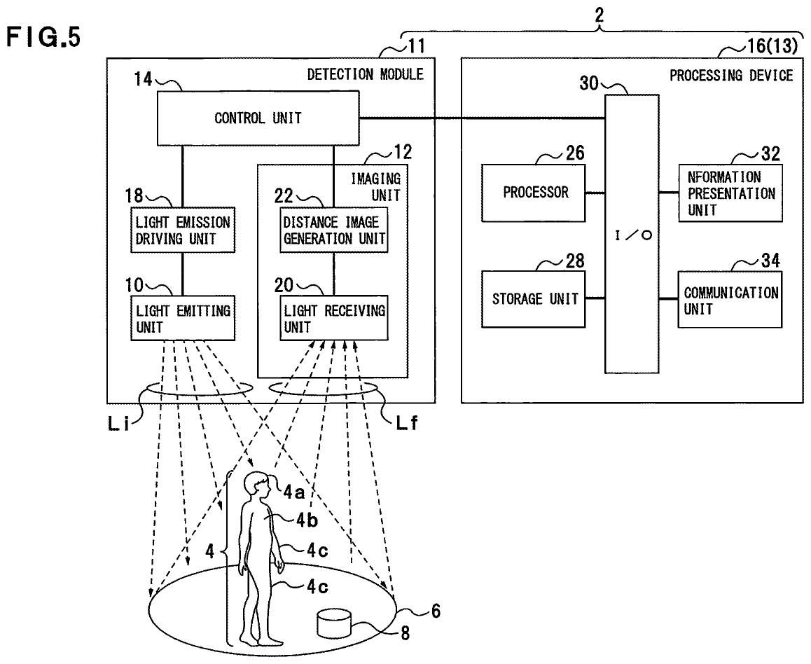

The detection module 11 is an example of an imaging unit of the present disclosure. The detection module 11 irradiates the target object 4 with intermittently emitted light Li, receives reflected light Lf from the target object 4 that has received the light Li, and generates the distance images Gd in time sequence. As a result, the detection module 11 acquires the distance image Gd indicating a distance between the target object 4 and the imaging unit 12 (FIG. 5) in time sequence in units of frames.

The processing unit 13 is an example of a processing unit of the present disclosure. In the present embodiment, the processing unit 13 is, for example, a personal computer, executes an operating system (OS) or the detection program of the present disclosure, executes information processing necessary for detecting the state of the target object 4, and detects the state of the target object 4.

### <State Detection of Target Object 4>

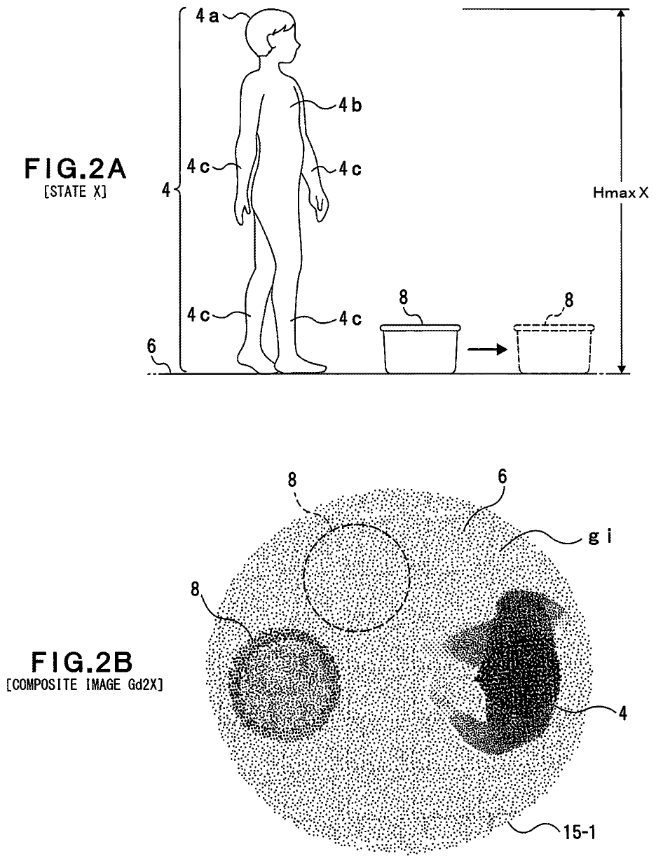

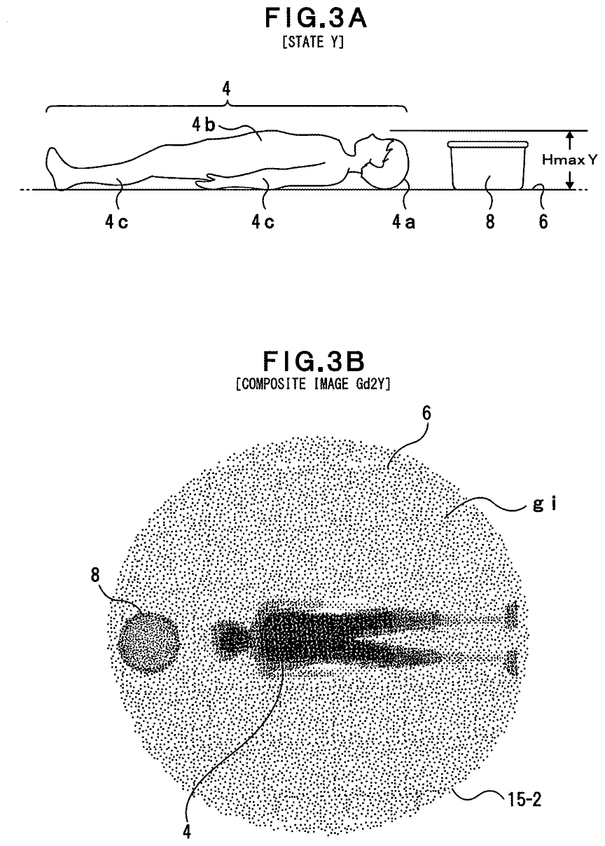

Since the detection system 2 detects the state of the target object 4 using the distance image Gd, unlike a normal optical camera, the target object 4 cannot be visually recognized from the distance image Gd. Therefore, the target object 4 is displayed as a real image with reference to a state X (FIG. 2) and a state Y (FIG. 3), and the relationship with the distance image Gd is clearly indicated.

FIG. 2A illustrates the target object 4, the background 6, and the object 8 in the state X. In this case, the target object 4 indicates a human in a standing state.

FIG. 2B illustrates the composite image Gd2X acquired by the detection module 11 from above the target object 4 in the state X. Since the composite image Gd2X in the frame 15-1 includes the target object 4, the background 6, and the object 8, a distance image GdX of the target object 4 can be extracted by removing a background image Gd1X including the background 6 and the object 8 from the composite image Gd2X. The distance image GdX indicates the virtual area VsX of the target object 4.

Therefore, a maximum height of the target object 4 is set to HmaxX. The maximum height HmaxX is an example of the distance of the present disclosure, and is distance information indicating the distance between the target object 4 and the imaging unit 12 in the present embodiment. That is, since the maximum height HmaxX of the target object 4 indicates a minimum distance between the target object 4 and the imaging unit 12, the distance information can be used to indicate the distance between the target object 4 and the imaging unit 12 or the maximum height HmaxX of the target object 4.

A virtual volume of the target object 4 is defined as VvX. The virtual volume VvX indicates a virtual volume of the target object 4 of the present disclosure. This virtual volume VvX can be expressed by Expression 1 using the virtual area VsX and the maximum height HmaxX.

VvX=VsX·HmaxX (Expression 1)

n this state X, even when the object 8 moves as indicated by a broken line, the distance image GdX of the target object 4 can be extracted by removing the background image Gd1X including the background 6 and the object 8 from the composite image Gd2X. The target object 4 can be detected from the distance image GdX.

The virtual volume Vvx may be calculated using the sum of the heights, and the virtual volume Vvx can be expressed by Expression 2.

Vvx=ΣGdx (Expression 2)

In Expression 2, ΣGdx indicates the sum of the height information of the target object 4.

FIG. 3A illustrates the target object 4 that have changed from the state X to the state Y, the background 6, and the object 8. In this case, the target object 4 indicates a human in a supine state.

FIG. 3B illustrates a composite image Gd2Y acquired by the detection module 11 from above the target object 4 in the state Y. Since the composite image Gd2Y in a frame 15-2 includes the target object 4, a distance image GdY of the target object 4 in the state Y can be similarly extracted by removing a background image Gd1Y from the composite image Gd2Y. The distance image GdY indicates the virtual area VsY of the target object 4.

Therefore, when the maximum height of the target object 4 is HmaxY and the virtual area of the target object 4 is VsY, the virtual volume VvY can be expressed by Expression 3.

VvY=VsY·HmaxY (Expression 3)

As described above, when the target object 4 transitions from the state X to the state Y, the maximum height HmaxX of the target object 4 changes to HmaxY, and the virtual area thereof changes from VsX to VsY. Therefore, from the comparison between the maximum heights HmaxX and HmaxY and the comparison between the virtual areas VsX and VsY, it is possible to recognize that the target object 4 has changed from the state X to the state Y.

### <Processing Procedure for State Detection of Target Object 4>

This processing procedure illustrates a processing procedure of state detection using the distance image Gd acquired by the imaging of the detection module 11.

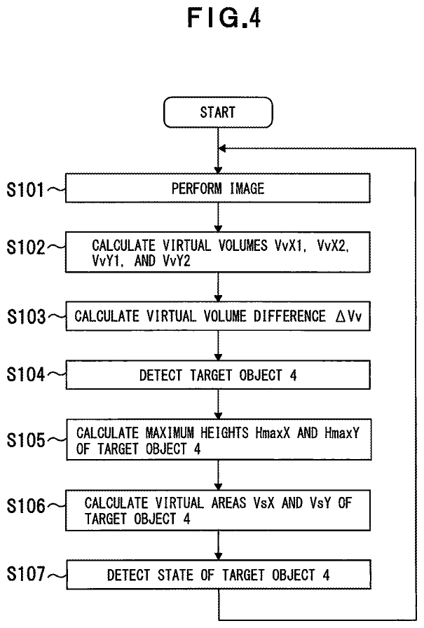

FIG. 4 illustrates an example of a processing procedure of state detection of the target object 4. This processing procedure includes imaging (S101), calculation of virtual volumes VvX1, VvX2, VvY1, and VvY2 (S102), calculation of virtual volume difference ΔVv (S103), detection of target object 4 (S104), calculation of maximum height HmaxX and maximum height HmaxY of target object 4 (S105), calculation of virtual areas VsX and VsY of target object 4 (S106), state detection of target object 4 (S107), and the like.

The detection module 11 performs imaging (S101), and acquires the background image Gd1 and the composite image Gd2 of the state X and the state Y by the imaging.

The processing unit 13 calculates the virtual volumes VvX1 and VvX2 including the target object 4 in the state X by using the composite image Gd2X in the state X according to the information processing of the processor 26 (FIG. 5) (S102). The virtual volumes VvX1 and VvX2 are virtual volumes on different frames. The volume difference ΔVv between the virtual volumes VvX1 and VvX2 is calculated (S103), and the presence of the target object 4 in the background 6 is detected. Even when the object 8 on the background 6 moves, the target object 4 having a specific volume can be detected without being affected by the movement, and the presence of the target object 4 can be known.

The processing unit 13 calculates the maximum height HmaxX and the maximum height HmaxY of the target object 4 from the distance image GdX of the state X and the distance image GdY of the state Y of the detected target object 4, for example (S105), and calculates the virtual areas VsX and VsY of the target object 4 (S106).

Then, the processing unit 13 detects the state of the target object 4 by comparing the maximum heights HmaxX and HmaxY and comparing the virtual areas VsX and VsY (S107).

### Effects of First Embodiment

According to the first embodiment, any one of the following effects can be obtained.

(1) The virtual volume Vv indicating the target object 4 can be acquired using the pixels gi included in the distance image Gd, the target object 4 can be detected using the change in the virtual volume Vv, and the state such as the abnormality of the target object 4 can be detected quickly with high accuracy.

(2) In a case where the target object 4 can be specified from the distance image Gd and the target object 4 is, for example, a human, information other than the state of the target object can be omitted from the attribute information such as the gender, the information used for the detection processing can be reduced, the load of the information processing can be reduced, and the processing can be speeded up.

(3) After the target object 4 is specified, it is possible to accurately perform state detection indicating abnormality or normality of the target object by comparison between frames of the distance images Gd.

### Second Embodiment

FIG. 5 illustrates a detection system 2 and a detection target according to the second embodiment. The configuration illustrated in FIG. 5 is an example, and the present disclosure is not limited to such a configuration. In FIG. 5, the same portions as those in FIG. 1 are denoted by the same reference numerals.

The detection system 2 includes a light emitting unit 10, an imaging unit 12, a control unit 14, a processing device 16, and the like. The light emitting unit 10 receives a drive output from a light emission driving unit 18 under the control of the control unit 14 to cause intermittent light emission, and irradiates the target object 4 with the light Li. Reflected light Lf is obtained from the target object 4 that has received the light Li. The time from the time point of emission of the light Li to the time point of reception of the reflected light Lf indicates a distance. The imaging unit 12 is an example of an imaging unit of the present disclosure. The imaging unit 12 includes a light receiving unit 20 and a distance image generation unit 22. The light receiving unit 20 receives the reflected light Lf from the target object 4 in time sequence in synchronization with the light emission of the light emitting unit 10 under the control of the control unit 14, and outputs a light reception signal. The distance image generation unit 22 receives the light reception signal from the light receiving unit 20 and generates the distance images Gd in time sequence. Therefore, the distance image Gd indicating the distance between the target object 4 and the imaging unit 12 is acquired in units of frames in time sequence.

The control unit 14 includes, for example, a computer, and executes light emission control of the light emitting unit 10 and imaging control of the imaging unit 12 by executing an imaging program. The light emitting unit 10, the imaging unit 12, the control unit 14, and the light emission driving unit 18 are an example of the detection module 11 of the present disclosure, and can be configured by, for example, a one-package discrete element such as a one-chip IC. The detection module 11 constitutes, for example, the ToF camera.

The processing device 16 is an example of the processing unit 13 of the present disclosure. In the present embodiment, the processing device 16 is, for example, a personal computer having a communication function, and includes a processor 26, a storage unit 28, an input/output unit (I/O) 30, an information presentation unit 32, a communication unit 34, and the like.

The processor 26 executes the OS and the detection program of the present disclosure in the storage unit 28, and executes information processing necessary for detecting the state of the target object 4.

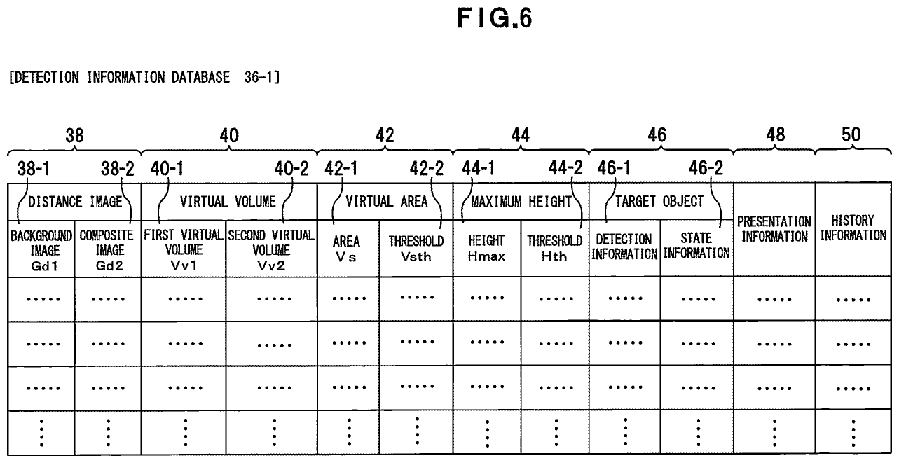

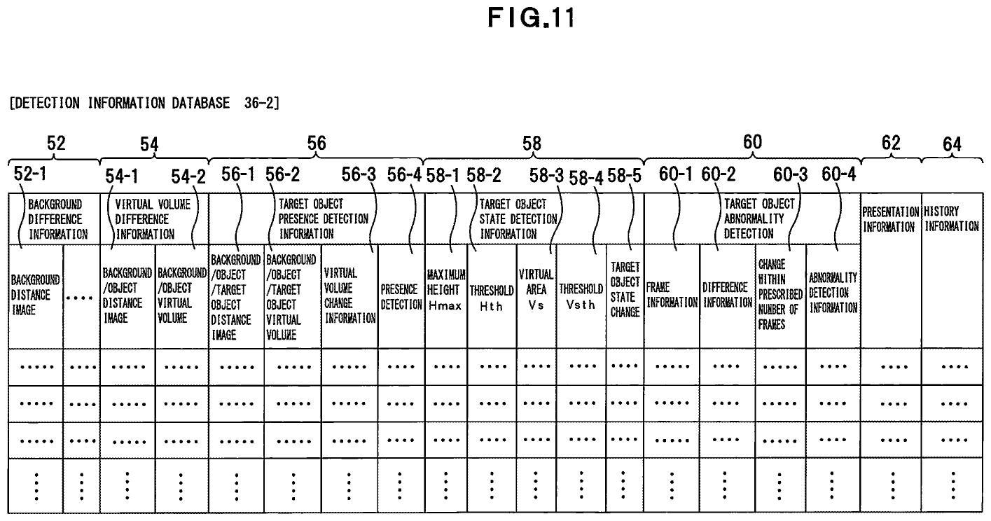

The storage unit 28 stores the OS, the detection program, detection information databases (DB) 36-1 (FIG. 6) and 36-2 (FIG. 11) used for information processing necessary for the state detection, and the like. The storage unit 28 includes storage elements such as a read-only memory (ROM) and a random-access memory (RAM). The input/output unit 30 inputs and outputs information under the control of the processor 26.

In addition to the information presentation unit 32, an operation input unit (not illustrated) is connected to the input/output unit 30. The input/output unit 30 receives operation input information by a user operation or the like, and obtains output information based on information processing of the processor 26.

The information presentation unit 32 is an example of the information presentation unit of the present disclosure, and includes, for example, a liquid crystal display (LCD). The information presentation unit 32 presents presentation information including one or more of the distance image Gd, the virtual volume Vv, the maximum height Hmax, the virtual area Vs, and the state information Sx indicating the state of the target object 4 under the control of the processor 26. As the operation input unit, for example, a touch panel installed on a screen of an LCD of the information presentation unit 32 may be used.

The communication unit 34 is connected to an information device such as a communication terminal (not illustrated) in a wired or wireless manner through a public line or the like under the control of the processor 26, and can present state information of the target object 4 and the like to the communication terminal.

### <Control by Control Unit 14>

The control by the control unit 14 includes processing such as a) light emission control of the light Li, b) light reception control of the reflected light Lf, c) generation processing of the distance image Gd, and d) transmission control of the distance image Gd.

### a) Light Emission Control of Light Li

The control unit 14 performs light emission control of the light emitting unit 10 in order to generate the reflected light Lf from the target object 4. In order to cause the light emitting unit 10 to intermittently emit light, a drive signal is provided from the light emission driving unit 18 to the light emitting unit 10 under the control of the control unit 14. As a result, the light emitting unit 10 emits intermittent light Li to irradiate the target object 4.

### b) Light Reception Control of Reflected Light Lf

In order to receive the reflected light Lf from the target object 4 that has received the light Li, the control unit 14 performs light reception control of the light receiving unit 20. As a result, the reflected light Lf from the target object 4 is received by the light receiving unit 20. By this light reception, a light reception signal is generated from the light receiving unit 20 and provided to the distance image generation unit 22.

### c) Generation Processing of Distance Image Gd

Under the control of the control unit 14, the distance image generation unit 22 generates the distance image Gd using the light reception signal. The distance image Gd includes pixels gi indicating different light receiving distances depending on unevenness and a distance of the target object 4.

### d) Transmission Control of Distance Image Gd

The control unit 14 receives the distance image Gd from the distance image generation unit 22 and transmits the distance image Gd to the processing device 16 in units of frames.

### <Information Processing by Processing Device 16>

The information processing of the processing device 16 includes processing such as

e) acquisition of the distance image Gd, f) calculation of the virtual volume Vv, g) detection of the target object 4, h) calculation of the maximum height Hmax and the virtual area Vs, i) state detection of the target object 4, j) abnormality detection of the target object 4, k) presentation of the distance image Gd, the virtual volume Vv, the maximum height Hmax, the virtual area Vs, and the state information Sx, and 1) generation and update of the DB 36-1.

### e) Acquisition of Distance Image Gd

The processing device 16 acquires the distance images Gd in time sequence under the control of the processor 26. The distance image Gd is executed in units of frames. The distance images Gd include the background image Gd1 and the composite image Gd2. Since the background image Gd1 and the composite image Gd2 have been described above, detailed description thereof will be omitted.

### f) Calculation of Virtual Volume Vv

The processing device 16 calculates a first virtual volume Vv1 indicating the background 6 from the background image Gd1, and calculates a second virtual volume Vv2 indicating the target object 4 from the composite image Gd2Z.

Assuming that g1 is the number of the pixels gi included in the background image Gd1, that g2 is the number of the pixels gi included in the composite image Gd2, and that η is a conversion coefficient for converting the number of the pixels gi into a volume, the first virtual volume Vv1 and the second virtual volume Vv2 can be expressed by Expressions 4 and 5.

Vv1=η·g1 (Expression 4)

Vv2=η·g2 (Expression 5)

### g) Detection of Target Object 4

The processing device 16 compares the first virtual volume Vv1 with the second virtual volume Vv2 to detect the target object 4. That is, when the virtual volume of the target object 4 is Vvx, it can be expressed by Expression 6.

Vvx=Vv2−Vv1=η·(g2−g1)=η·Δg (Expression 6)

In Expression 6, Δg is the number of pixels indicating the target object 4 (g2-g1).

### h) Calculation of Maximum Height Hmax and Virtual Area Vs

When the maximum height of the target object 4 obtained from the distance image Gd is Hmax and the virtual area thereof is Vs, the processing device 16 can express the virtual area Vs of the target object 4 by Expression 7.

Vs=Vvx+Hmax=η·Δg+Hmax (Expression 7)

In addition, the processing device 16 can obtain the maximum height Hmax of the target object 4 from the background 6 where the target object 4 exists using the pixels gi.

### i) State Detection of Target Object 4

The processing device 16 detects a state change of the target object 4 from the maximum height Hmax or the virtual area Vs. The processing device 16 sets a threshold Hth for the maximum height Hmax and a threshold Vsth for the virtual area Vs, detects whether the height H is equal to or more than the threshold Hth or less than the threshold Hth, and detects whether the virtual area Vs is equal to or more than the threshold Vsth or less than the threshold Vsth.
j) Abnormality Detection of Target Object 4

The processing device 16 detects an abnormality when a change in the target object 4 obtained by comparing the distance image between two or more frames is less than a threshold.

### k) Presentation of Distance Image Gd, Virtual Volume Vv, Maximum Height Hmax, Virtual Area Vs, and State Information Sx

The processing device 16 presents the background image Gd1, the composite image Gd2, the virtual volumes Vv1 and Vv2, the maximum height Hmax, the virtual area Vs, and the state information Sx to the information presentation unit 32 under the control of the processor 26. According to these pieces of presentation information, it is possible to visually recognize the determination information indicating the presence and the state of the target object 4, and whether the state of the target object 4 is normal or abnormal.

For this information presentation, under the control of the processor 26 from the processing device 16, the communication unit 34 and the corresponding communication terminal can be wirelessly connected, and information presentation similar to that of the information presentation unit 32 can be performed on the communication terminal.

### 1) Generation and Update of DB 36-1

The processing device 16 generates and updates the DB 36-1 stored in the storage unit 28 under the control of the processor 26.

### <DB36-1>

The DB 36-1 is an example of a database of the present disclosure. The DB 36-1 stores control information, detection information, and the like for detecting the state of the target object 4.

FIG. 6 illustrates an example of the DB 36-1. The DB 36-1 includes a distance image unit 38, a virtual volume unit 40, a virtual area unit 42, a maximum height unit 44, a target object unit 46, a presentation information unit 48, and a history information unit 50.

A background image unit 38-1 and a composite image unit 38-2 are set in the distance image unit 38. The background image unit 38-1 stores a background image Gd1 that is a distance image of a background image. The composite image unit 38-2 stores a composite image Gd2 which is a distance image of the composite image.

A first virtual volume unit 40-1 and a second virtual volume unit 40-2 are set in the virtual volume unit 40. The first virtual volume unit Vv1 is stored in the first virtual volume unit 40-1. The second virtual volume unit Vv2 is stored in the second virtual volume unit 40-2.

An area unit 42-1 and a threshold unit 42-2 are set in the virtual area unit 42. Area data indicating the virtual area Vs is stored in the area unit 42-1. The threshold unit 42-2 stores data indicating the threshold Vsth of the virtual area Vs.

A height unit 44-1 and a threshold unit 44-2 are set in the maximum height unit 44. Length data indicating the maximum height Hmax is stored in the height unit 44-1. The threshold unit 44-2 stores data indicating the threshold Hth of the maximum height Hmax.

A detection information unit 46-1 and a state detection unit 46-2 are set in the target object unit 46. Detection information of the target object 4 is stored in the detection information unit 46-1. State information indicating whether the target object 4 is normal or abnormal, which is obtained from the detection information, is stored in the state detection unit 46-2.

The presentation information unit 48 stores presentation information such as the distance image Gd, the virtual volume Vv, the maximum height Hmax, the virtual area Vs, the detection information, and the state information.

The history information unit 50 stores history information indicating a history of information detection and presentation information and the like.

Although not illustrated, a date-and-time information unit may be set in the DB 36-1, and date-and-time information indicating the date and time when the state of the target object 4 is detected may be stored.

### <Processing Procedure for State Detection of Target Object 4>

This processing procedure illustrates a processing procedure of state detection using the distance image Gd acquired by the imaging of the detection module 11.

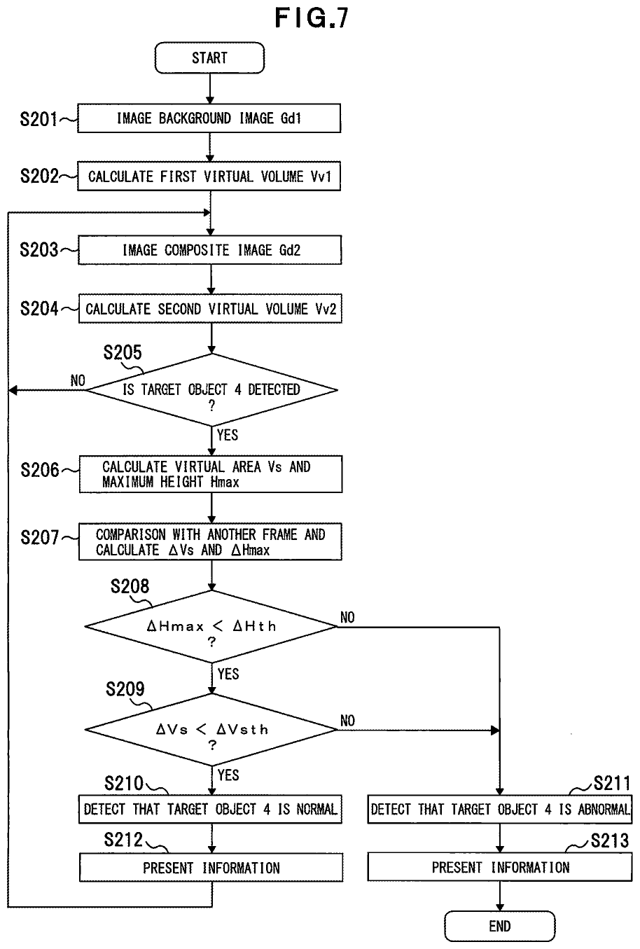

FIG. 7 illustrates an example of the processing procedure of the state detection of the target object 4. This processing procedure includes imaging of the background image Gd1 (S201), calculation of the first virtual volume Vv1 (S202), imaging of the composite image Gd2 (S203), calculation of the second virtual volume Vv2 (S204), detection of the target object 4 (S205), calculation of the virtual area Vs and the maximum height Hmax (S206), comparison with another frame and calculation of ΔVs and ΔHmax (S207), comparison of ΔHmax and ΔHth (S208), comparison of ΔVs and ΔVsth (S209), normality detection of the target object 4 (S210), abnormality detection of the target object 4 (S211), information presentation (S212, S213), and the like.

The imaging unit 12 images the background image Gd1 under the control of the control unit 14 (S201). The processing device 16 calculates the first virtual volume Vv1 (S202). The imaging unit 12 images the composite image Gd2 under the control of the control unit 14 (S203). The processing device 16 or the control unit 14 calculates the second virtual volume Vv2 (S204). The processing device 16 acquires the background image Gd1 and the composite image Gd2 from the imaging unit 12 and stores the acquired images in the DB 36-1.

The processing device 16 determines whether the target object 4 is detected from the second virtual volume Vv2 using the first virtual volume Vv1 and the second virtual volume Vv2 by the information processing of the processor 26 (S205).

The processing device 16 calculates the virtual area Vs and the maximum height Hmax by the information processing of the processor 26 (S206), and stores the calculation result in the DB 36-1.

The processing device 16 compares ΔHmax calculated by comparison with another frame with threshold ΔHth by the information processing of the processor 26, and determines a magnitude relationship between ΔHmax and the threshold ΔHth (S208).

According to the information processing of the processor 26, in a case where ΔHmax<ΔHth is satisfied (YES in S208), the processing device 16 can determine that a normality of the target object 4 is detected, compares ΔVs calculated by comparison with another frame with threshold ΔVsth, and determines the magnitude relationship between ΔVs and the threshold ΔVsth (S209). When ΔVs<ΔVsth (YES in S209), normality detection of the target object 4 is determined (S210).

When ΔHmax<ΔHth is not satisfied in S208 (NO in S208), it is determined that an abnormality of the target object 4 is detected (S211). When ΔVs<ΔVsth is not satisfied in S209 (NO in S209), it is similarly determined that an abnormality of the target object 4 is detected (S211).

The processing device 16 executes information presentation (S212, S213) under the control of the processor 26, and information such as the detection information, the distance image Gd, and normal information indicating that the target object 4 is normal is presented in the information presentation according to S212. In the information presentation related to S213, information such as the detection information, the distance image Gd, and abnormality information indicating that the target object 4 is abnormal is presented.

Then, in a case where there is an abnormality in the target object 4, this processing ends, and in a case where the target object is normal, the process returns from S212 to S203, and the state detection is continued.

### <State Detection of Target Object 4>

The target object 4 for state detection is, for example, a human, but the distance image Gd obtained from the detection module 11 is a set of pixels gi indicating the distance between the light receiving unit 20 and the target object 4. Therefore, in order to simulate the state detection of the target object 4, a real image of the target object 4 is exemplified as an example.

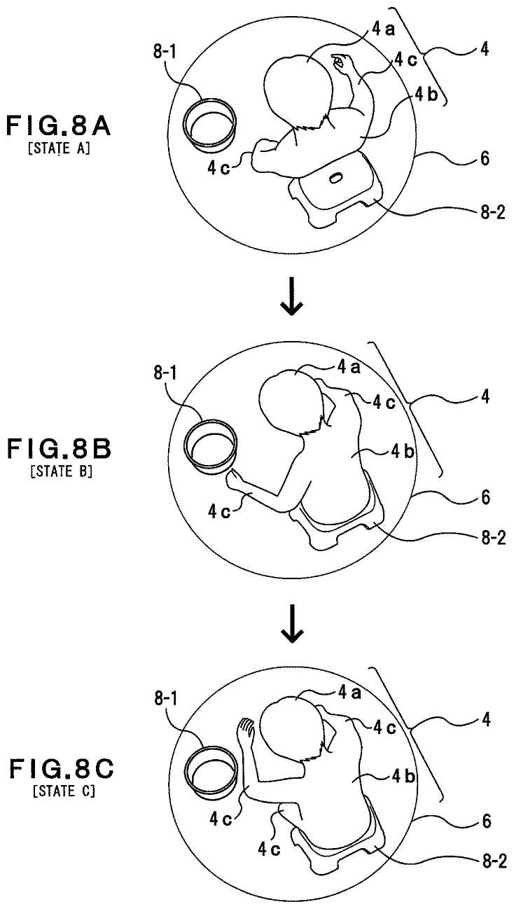

FIG. 8 illustrates an example of the behavior of the target object 4. This behavior includes, for example, a state A (A in FIG. 8), a state B (B in FIG. 8), and a state C (C in FIG. 8).

The state A illustrates a standing state of target object 4 as viewed from light receiving unit 20 above the head.

The state B illustrates a squatting state of the target object 4 shifted from the state A as viewed from the light receiving unit 20 above the head.

The state C illustrates the squatting state of the target object 4 shifted from the state B as viewed from the light receiving unit 20 above the head. In the state C, the left arm moves upward in the drawing from the state B.

In the behavior of the target object 4, as a simulation of state detection, a state in which the behavior of the target object 4 stops in the state B and there is no fluctuation even after a certain period of time, for example, is determined to be an abnormal state. Meanwhile, when a behavior occurs in the target object 4 such as transition from the state B to the state C, it is determined as a normal state.

### <Background Image Gd1, Composite Image Gd2, First Virtual Volume Vv1, Second Virtual Volume Vv2, Target Object Image Gdt, and State Detection Information of States A, B, and C>

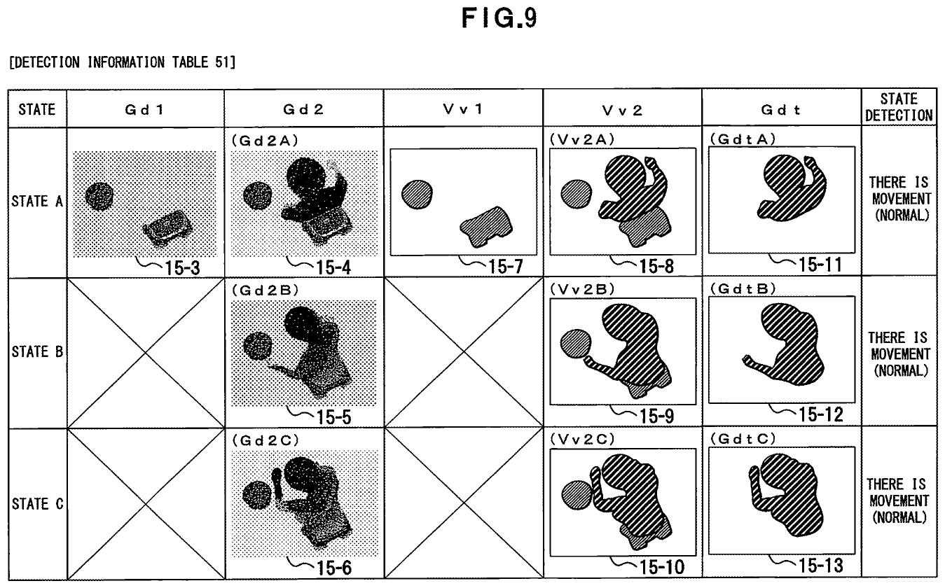

FIG. 9 illustrates an example of a detection information table 51. The detection information table 51 indicates the background image Gd1, the composite image Gd2, the first virtual volume Vv1, the second virtual volume Vv2, the target object image Gdt, and the state detection information for the states A, B, and C.

The background image Gd1 in a frame 15-3 is common to the states A, B, and C. In the composite image Gd2, Gd2A in a frame 15-4 corresponds to the real image of the state A illustrated in FIG. 8A, Gd2B in a frame 15-5 corresponds to the real image of the state B illustrated in FIG. 8B, and Gd2C in a frame 15-6 corresponds to the real image of the state C illustrated in FIG. 8C.

The first virtual volume Vv1 in a frame 15-7 corresponds to Gd1 and is obtained from the background image Gd1.

In the second virtual volume Vv2, Vv2A in a frame 15-8 is obtained from the composite image Gd2A, Vv2B in a frame 15-9 is obtained from Gd2B, and Vv2C in a frame 15-10 is obtained from Gd2C.

In the target object image Gdt, GdtA in a frame 15-11 is obtained from the second virtual volume Vv2A, GdtB in a frame 15-12 is obtained from Vv2B, and GdtC in a frame 15-13 is obtained from Vv2C.

Then, by comparing the target object images GdtA, GdtB, and GdtC, the behavior state of the target object 4 can be detected. In this case, in the state detection, the state A indicates that there is movement of the target object 4, the state A to the state B similarly move, and the state B to the state C similarly move. Therefore, in this case, the state detection indicates that the target object 4 is normal.

### Effects of Second Embodiment

According to the second embodiment, any one of the following effects can be obtained.
(1) The second virtual volume Vv2 indicating the target object 4 can be acquired using the pixels gi included in the distance image Gd (background image Gd1 and composite image Gd2), and the target object 4 is detected using the difference of the second virtual volume Vv2. Therefore, the target object 4 of a specific volume can be detected without being affected by movement of the object 8 or the like.
(2) Since the state of the target object 4 is detected using the variation of the second virtual volume Vv2 of the target object 4, it is possible to realize detection processing with high confidentiality without being affected by attribute information such as the shape and gender of the object 8.
(3) Since the state of the target object 4 can be detected mainly using the pixels gi indicating the target object 4, the load of information processing required for detection can be reduced, resources required for processing can be reduced, and processing can be speeded up.
(4) Since the target object 4 is not limited to a stationary body or a moving body, and the virtual volume can be accurately calculated using the distance image, it is possible to perform highly accurate state detection without being affected by a difference between pixels such as distance measurement and height measurement.

### Third Embodiment

In a third embodiment, a distance image of only the background 6 is a background distance image GdA, a distance image including the background 6 and the object 8 is a background/object distance image GdB, and a distance image including the target object 4, the background 6, and the object 8 is a background/object/target object distance image GdC.

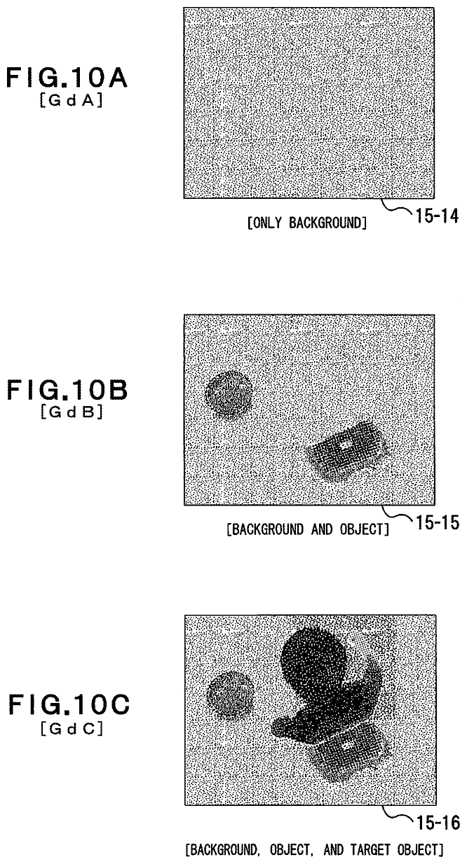

FIG. 10A illustrates an example of the background distance image GdA imaged in a frame 15-14, FIG. 10B illustrates an example of the background/object distance image GdB imaged in a frame 15-15, and FIG. 10C illustrates an example of the background/object/target object distance image GdC imaged in a frame 15-16.

### Detection System 2 According to Third Embodiment

The detection system 2 according to the third embodiment has the same configuration as the configuration illustrated in FIG. 5, and thus description thereof is omitted.

### Control by Control Unit 14 According to Third Embodiment

Similarly, the control by the control unit 14 according to the third embodiment includes processing such as a) light emission control of the light Li, b) light reception control of the reflected light Lf, c) generation processing of the distance image Gd, and d) transmission control of the distance image Gd. Since these controls are similar to those of the second embodiment, the description thereof will be omitted.<Information Processing by Processing Device 16>

The information processing of the processing device 16 includes processing such as m) acquisition of the distance image Gd, n) acquisition of the background difference information, o) acquisition of the virtual volume difference information, p) presence detection of the target object 4, q) state detection of the target object 4, r) abnormality detection of the target object 4, s) presentation of the distance image, the virtual volume, the virtual area, the maximum height Hmax, and the state information, and t) generation and update of the DB 36-2.

### m) Acquisition of Distance Image Gd

The processing device 16 acquires the background distance image GdA, the background/object distance image GdB, and the background/object/target object distance image GdC in time sequence under the control of the processor 26. GdA, GdB, and GdC are executed in units of frames.

### n) Acquisition of Background Difference Information

Under the control of the processor 26, the processing device 16 calculates a background difference between the background distance image GdA and the background/object distance image GdB, and a background difference between the background/object distance image GdB and the background/object/target object distance image GdC, and stores the background differences in the DB 36-2 (FIG. 11).

### o) Acquisition of Virtual Volume Difference Information

Under the control of the processor 26, the processing device 16 compares the virtual volume VvA with the virtual volume VvB, and acquires change information (virtual volume difference information) indicating the change.

### p) Presence Detection of Target Object 4

The processing device 16 detects the presence of the target object 4 by using the virtual volume difference information under the control of the processor 26.

### q) State Detection of Target Object 4

The processing device 16 calculates the maximum height Hmax and the virtual area Vs of the target object 4 by using the background/object/target object distance image GdC under the control of the processor 26. The state of the target object 4 is detected using the maximum height Hmax and the virtual area Vs.

### r) Abnormality Detection of Target Object 4

The processing device 16 compares the background/object/target object distance image GdC of the previous frame with the background/object/target object distance image GdC of the current frame under the control of the processor 26, obtains a difference therebetween, and detects a change within a predetermined number of frames when there is the difference therebetween. When there is this change, the target object 4 is detected to be normal, and when there is no change, the target object 4 is detected to be abnormal.

### s) Presentation of Distance Image, Virtual Volume, Virtual Area, Maximum Height Hmax, and State Information

The processing device 16 presents the distance image Gd, the virtual area for each block, the state information, and the determination information to the information presentation unit 32 under the control of the processor 26. According to these pieces of presentation information, it is possible to visually recognize the determination information indicating the presence and the state of the target object 4, and whether the state of the target object 4 is normal or abnormal.

For this information presentation, under the control of the processor 26 from the processing device 16, the communication unit 34 and the corresponding communication terminal can be wirelessly connected, and information presentation similar to that of the information presentation unit 32 can be performed on the communication terminal.

### t) Generation and Update of DB 36-2.

The processing device 16 generates and updates the DB 36-2 stored in the storage unit 28 under the control of the processor 26.

### <DB36-2>

Similarly to the second embodiment, the DB 36-2 stores the control information of the control unit 14 for state detection of the target object 4, the control information of the processing device 16, the processing information of the distance image Gd, the state detection information of the target object 4, and the like.

FIG. 11 illustrates an example of the DB 36-2. The DB 36-2 is an example of a database of the present disclosure. The DB 36-2 includes a background difference information unit 52, a virtual volume difference information unit 54, a target object presence detection information unit 56, a target object state detection information unit 58, a target object abnormality detection unit 60, a presentation information unit 62, and a history information unit 64.

The background difference information unit 52 stores a background distance image GdA (52-1) as background difference information.

In the virtual volume difference information unit 54, a background/object distance image unit 54-1 and a background/object virtual volume unit 54-2 are set. The background/object distance image unit 54-1 stores the background/object distance image GdB. The background/object virtual volume unit 54-2 stores the background/object virtual volume VvB calculated from the background/object distance image GdB.

In the target object presence detection information unit 56, a background/object/target object distance image unit 56-1, a background/object/target object virtual volume unit 56-2, a virtual volume change information unit 56-3, and a presence detection information unit 56-4 are set. The background/object/target object distance image unit 56-1 stores the background/object/target object distance image GdC. The background/object/target object virtual volume unit 56-2 stores the background/object/target object virtual volume VvC acquired from the background/object/target object distance image GdC. The virtual volume change information unit 56-3 stores virtual volume change information. The presence detection information unit 56-4 stores presence detection information indicating the presence of the target object 4 detected from the change in the virtual volume.

In the target object state detection information unit 58, a maximum height unit 58-1, a threshold unit 58-2, a virtual area unit 58-3, a threshold unit 58-4, and a target object state changing unit 58-5 are set. The maximum height unit 58-1 stores the maximum height Hmax of the target object 4 acquired from the background/object/target object distance image GdC. The threshold Hth for the maximum height Hmax is stored in the threshold unit 58-2. The virtual area unit 58-3 stores the virtual area Vs of the target object 4 acquired from the background/object/target object distance image GdC. The threshold Vsth for the virtual area Vs is stored in the threshold unit 58-4. The target object state changing unit 58-5 stores change information indicating a state change of the target object 4 calculated from the maximum height Hmax and the virtual area Vs.

In the target object abnormality detection unit 60, a frame information unit 60-1, a difference information unit 60-2, a change unit within prescribed number of frames 60-3, and an abnormality detection information unit 60-4 are set. The frame information unit 60-1 stores frame information as a target of the background/object/target object distance image GdC to be compared. The difference information unit 60-2 stores difference information between frames obtained by comparing the background/object/target object distance image GdC of the previous frame with the background/object/target object distance image GdC of the current frame. The change unit within prescribed number of frames 60-3 stores change information of the background/object/target object distance image GdC together with the number of frames to be compared. The abnormality detection information unit 60-4 stores normal information or abnormality information of the target object 4 detected from the presence or absence of a change in the background/object/target object distance image GdC.

The presentation information unit 62 stores presentation information such as the distance image Gd.

The history information unit 64 stores history information indicating a history such as a sensing history and a state history.

### <Processing Procedure for State Detection of Target Object 4>

This processing procedure is a processing procedure of state detection using three distance images of the background distance image GdA, the background/object distance image GdB, and the background/object/target object distance image GdC.

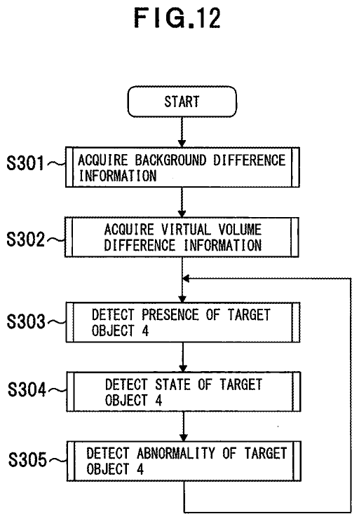

FIG. 12 illustrates a processing procedure of state detection of the target object 4. This processing procedure includes acquisition of background difference information (S301), acquisition of virtual volume difference information (S302), presence detection of the target object 4 (S303), state detection of the target object 4 (S304), and abnormality detection of the target object 4 (S305).

According to this processing procedure, under the control of the processor 26, the processing device 16 acquires the background difference information (S301), acquires the virtual volume difference information (S302), detects the presence of the target object 4 based on the information (S303), detects the state of the target object 4 (S304), detects the abnormality of the target object 4 (S305), and returns to S303.

### <Acquisition of Background Difference Information>

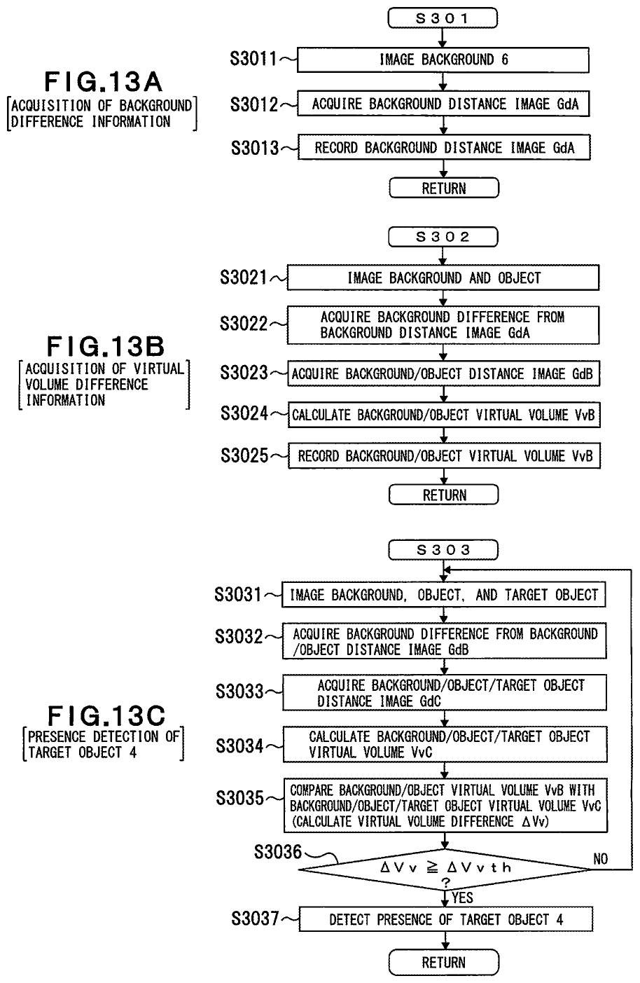

FIG. 13A illustrates a processing procedure of background difference information acquisition processing. In this processing procedure, the imaging unit 12 images the background 6 under the control of the control unit 14 (S3011), and the processing device 16 acquires the background distance image GdA under the control of the processor 26 (S3012). The background distance image GdA is stored and recorded in the DB 36-2 under the control of the processor 26 of the processing device 16 (S3013).

### <Acquisition of Virtual Volume Difference Information>

FIG. 13B illustrates a processing procedure of the virtual volume difference information acquisition processing. In this processing procedure, the imaging unit 12 images the background 6 including the object 8 under the control of the control unit 14 (S3021), and the processing device 16 acquires a background difference from the background distance image GdA under the control of the processor 26 (S3022).

The processing device 16 acquires the background/object distance image GdB from the control unit 14 (S3023), and calculates the background/object virtual volume VvB using the background/object distance image GdB (S3024). The background/object virtual volume VvB is stored and recorded in the DB 36-2 under the control of the processor 26 of the processing device 16 (S3025).

### <Presence Detection of Target Object 4>

FIG. 13C illustrates a processing procedure of detecting the presence of the target object 4. In this processing procedure, the imaging unit 12 images the target object 4, the background 6, and the object 8 under the control of the control unit 14 (S3031), and the processing device 16 acquires the background difference from the background/object distance image GdB under the control of the processor 26 (S3032).

The processing device 16 acquires the background/object/target object distance image GdC from the control unit 14 (S3033), and calculates the background/object/target object virtual volume VvC using the background/object/target object distance image GdC (S3034). The processing device 16 compares the background/object virtual volume VvB with the background/object/target object virtual volume VvC, and calculates a virtual volume difference ΔVv between them (S3035). The processing device 16 performs threshold determination of the virtual volume difference ΔVv under the control of the processor 26 (S3036).

When ΔVv>ΔVvth (YES in S3036), the presence of the target object 4 is detected (S3037). When ΔVv>ΔVvth is not satisfied (NO in S3036), the process returns to S3031.

### <State Detection of Target Object 4>

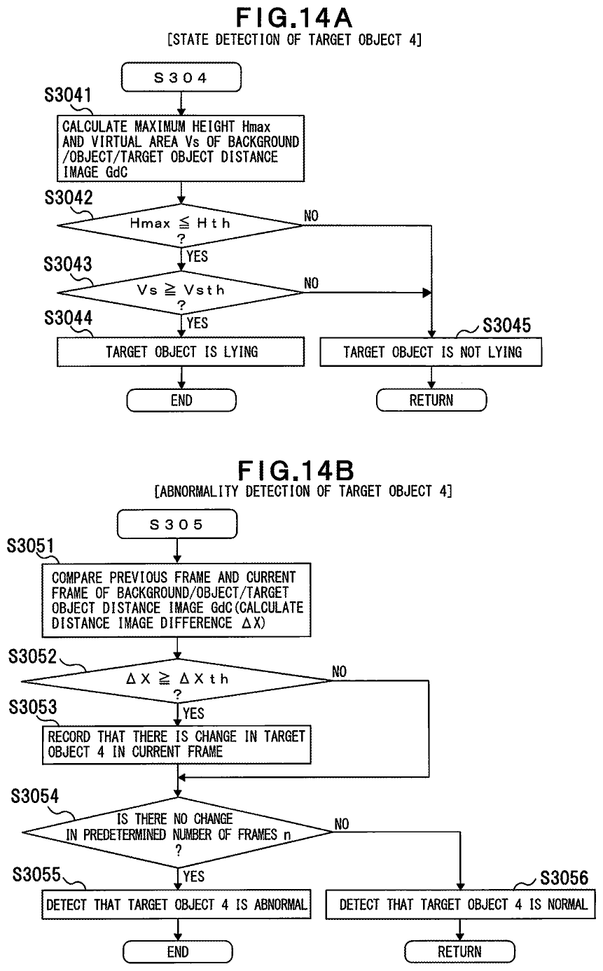

FIG. 14A illustrates a processing procedure of state detection of the target object 4. In this processing procedure, the imaging unit 12 calculates the maximum height Hmax and the virtual area Vs of the background/object/target object distance image GdC under the control of the control unit 14 (S3041), and performs the threshold Hth determination of the maximum height Hmax (S3042).

When Hmax<Hth (YES in S3042), the threshold Vsth of the virtual area Vs is determined (S3043). When Vs>Vsth (YES in S3043), it is detected that the target object 4 is lying (S3044).

When Hmax<Hth is not satisfied (NO in S3042), it is detected that the target object 4 is not lying (S3045). Similarly, When Vs>Vsth is not satisfied (NO in S3043), for example, it is detected that the object is not lying (S3045), and the state detection of the target object 4 is continued.<Abnormality Detection of Target Object 4>

FIG. 14B illustrates a processing procedure of abnormality detection of the target object 4. In this processing procedure, under the control of the control unit 14, the imaging unit 12 compares the previous frame and the current frame of the background/object/target object distance image GdC, calculates a distance image difference ΔX between the two (S3051), and performs threshold ΔXth determination of the distance image difference ΔX (S3052).

When ΔX>ΔXth (YES in S3052), it is detected that there is a change in the target object 4 in the current frame, this change information is recorded (S3053), and it is determined whether there is no change in the predetermined number of frames n (S3054). When ΔX>ΔXth is not satisfied (NO in S3052), the process skips S3053 and proceeds to S3054.

When there is no change in the predetermined number of frames n (YES in S3054), it is determined that an abnormality of the target object 4 is detected (S3055), and the processing is terminated. When it is detected that there is a change in the predetermined number of frames n (NO in S3054), normality of the target object 4 is detected (S3056), and the processing is continued.

### Effects of Third Embodiment

Also in the third embodiment, the same effects as those of the second embodiment can be obtained.

### Example

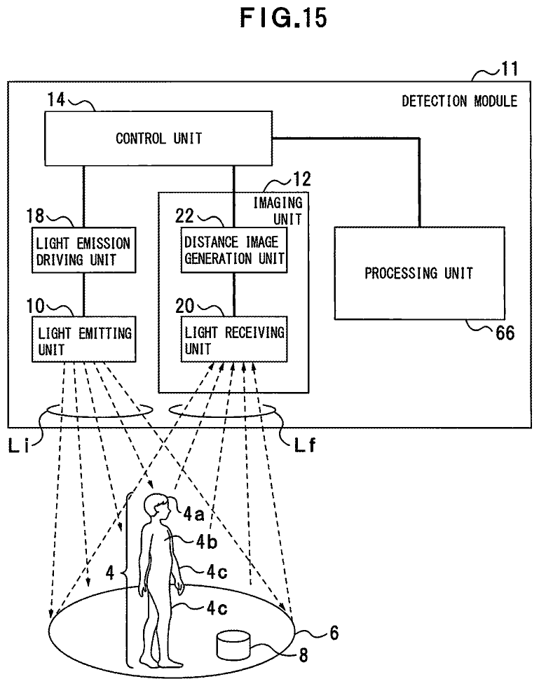

FIG. 15 exemplifies the conversion of the detection module 11 into one chip. The detection module 11 includes a processing unit 66 having a function equivalent to that of the processing device 16. In the detection module 11, the same reference numerals are given to the same parts as those of the detection system 2 described above, and the description thereof will be omitted.

### Effects of Example

According to this example, any one of the following effects can be obtained.
(1) It can be widely used for detecting the state of the target object 4 such as a human.
(2) The state of the target object 4 can be detected without considering privacy such as gender, and can be used for state detection in a bathroom, a toilet, or the like.

### Other Embodiments

(1) In the above embodiments, a human is exemplified as the target object 4, but a moving body other than a human, for example, a moving body such as an automobile or a robot may be used as the target object 4.
(2) In the above embodiments, a single detection module is exemplified. However, a plurality of detection modules obtained using a plurality of cameras may be used in combination.
(3) For the state detection of the target object 4, a detection time may be set, and whether the target object 4 is normal or abnormal may be detected from the presence or absence of behavior within the detection time.
(4) In the above embodiments, the processing device 16 may compare the virtual area or the virtual volume between the frames and detect the state variation of the target object 4 from the difference between previous and following.

According to an aspect of the embodiments or examples described above, a detection system, a detection method, a program, or a detection module is as follows.

According to an aspect of the detection system of the present disclosure, there is provided a detection system including: an imaging unit configured to acquire in advance a first distance image indicating a background and acquire a second distance image including at least the background and a target object; and a processing unit configured to calculate a first virtual volume indicating the background from the first distance image, calculate a second virtual volume indicating the target object from the second distance image, and compare the first virtual volume with the second virtual volume to detect the target object.

According to an aspect of the detection system of the present disclosure, there is provided a detection system including: an imaging unit configured to acquire in advance a first distance image indicating a background together with an object other than a target object to be detected, and acquire a second distance image including the background, the object, and the target object; and a processing unit configured to calculate a first virtual volume indicating the object and the background from the first distance image, calculate a second virtual volume indicating the target object and the object from the second distance image, and compare the first virtual volume with the second virtual volume to detect the target object.

In the detection system, the processing unit may calculate a distance of the target object from the imaging unit and/or a virtual area of the target object, and detect a state of the target object by using the distance from the imaging unit and/or the virtual area.

The detection system may include an information presentation unit configured to present one or more of the first distance image, the second distance image, a first virtual volume image, a second virtual volume image, a maximum height, a virtual area, and state information indicating a state of the target object.

According to an aspect of a detection method of the present disclosure, there is provided a detection method including: acquiring, by an imaging unit, a first distance image indicating a background for a target object to be detected in advance, and acquiring a second distance image including at least the background and the target object; and calculating, by a processing unit, a first virtual volume indicating the background from the first distance image, calculating a second virtual volume indicating the target object from the second distance image, and comparing the first virtual volume with the second virtual volume to detect the target object.

According to an aspect of a program of the present disclosure, there is provided a program for causing a computer to execute: acquiring in advance a first distance image indicating a background for a target object to be detected; acquiring a second distance image including at least the background and the target object; calculating a first virtual volume indicating the background from the first distance image; calculating a second virtual volume indicating the target object from the second distance image; and comparing the first virtual volume with the second virtual volume to detect the target object and calculating a maximum height from the target object or a virtual area of the target object.

According to an aspect of a detection module of the present disclosure, there is provided a detection module including: an imaging unit configured to acquire in advance a first distance image indicating a background for a target object to be detected and acquire a second distance image including at least the background and the target object; and a processing unit configured to calculate a first virtual volume indicating the background from the first distance image, calculate a second virtual volume indicating the target object from the second distance image, and compare the first virtual volume with the second virtual volume to detect the target object.

According to aspects of the embodiments or the examples, any of the following effects can be obtained.
(1) The virtual volume indicating the target object can be acquired using the pixels included in the distance image, the target object can be detected using the change in the virtual volume, and the state such as the abnormality of the target object can be detected quickly with high accuracy.
(2) Since the target object is specified from the distance image, in a case where the target object is, for example, a human, the attribute information such as the gender and the information other than the state of the target object can be omitted, the information used for the detection processing can be reduced, the load of the information processing can be reduced, and the processing can be speeded up.
(3) After the target object is specified, it is possible to perform state detection indicating abnormality or normality of the target object by comparison between frames of the distance images.

As described above, the most preferred embodiments of the present disclosure have been described. The technology of the present disclosure is not limited to the above description. Various modifications and changes can be made by those skilled in the art based on the gist of the disclosure described in the claims or disclosed in the specification. It goes without saying that such modifications and changes are included in the scope of the present disclosure.

According to the state detection system, the method, the program, and the detection module of the present disclosure, the presence and the state of the target object can be easily and accurately detected using the virtual volume image, the maximum height, and the virtual area calculated from the distance image obtained from the target object such as a human.

What is claimed is:

1. A detection system comprising:
an imaging unit configured to acquire in advance a first distance image indicating a background and acquire a second distance image including at least the background and a target object; and
a processing unit configured to calculate a first virtual volume indicating the background from the first distance image, calculate a second virtual volume indicating the target object from the second distance image, and compare the first virtual volume with the second virtual volume to detect the target object.

2. The detection system according to claim 1, wherein the processing unit calculates a distance of the target object from the imaging unit and/or a virtual area of the target object and detects a state of the target object by using the distance from the imaging unit and/or the virtual area.

3. The detection system according to claim 1, further comprising an information presentation unit configured to present one or more of the first distance image, the second distance image, a first virtual volume image, a second virtual volume image, a maximum height, a virtual area, and state information indicating a state of the target object.

4. A detection system comprising:
an imaging unit configured to acquire in advance a first distance image indicating a background together with an object other than a target object to be detected, and acquire a second distance image including the background, the object, and the target object; and
a processing unit configured to calculate a first virtual volume indicating the object and the background from the first distance image, calculate a second virtual volume indicating the target object and the object from the second distance image, and compare the first virtual volume with the second virtual volume to detect the target object.

5. The detection system according to claim 4, wherein the processing unit calculates a distance of the target object from the imaging unit and/or a virtual area of the target object and detects a state of the target object by using the distance from the imaging unit and/or the virtual area.

6. The detection system according to claim 4, further comprising an information presentation unit configured to present one or more of the first distance image, the second distance image, a first virtual volume image, a second virtual volume image, a maximum height, a virtual area, and state information indicating a state of the target object.

7. A detection method comprising:
acquiring, by an imaging unit, a first distance image indicating a background for a target object to be detected in advance, and acquiring a second distance image including at least the background and the target object; and
calculating, by a processing unit, a first virtual volume indicating the background from the first distance image, calculating a second virtual volume indicating the target object from the second distance image, and comparing the first virtual volume with the second virtual volume to detect the target object.

8. A non-transitory computer readable medium storing a program for causing a computer to execute:
acquiring in advance a first distance image indicating a background for a target object to be detected;
acquiring a second distance image including at least the background and the target object;
calculating a first virtual volume indicating the background from the first distance image;
calculating a second virtual volume indicating the target object from the second distance image; and
comparing the first virtual volume with the second virtual volume to detect the target object and calculating a maximum height from the target object or a virtual area of the target object.

9. A detection module comprising:
an imaging unit configured to acquire in advance a first distance image indicating a background for a target object to be detected and acquire a second distance image including at least the background and the target object; and
a processing unit configured to calculate a first virtual volume indicating the background from the first distance image, calculate a second virtual volume indicating the target object from the second distance image, and compare the first virtual volume with the second virtual volume to detect the target object.
